(19) United States
(12) Patent Application Publication
(10) Pub. No.: US 2025/0370712 A1
(43) Pub. Date: Dec. 4, 2025

(54) EXPONENT INDEXED ACCUMULATORS FOR FLOATING-POINT, POSITS AND LOGARITHMIC NUMBERS

(71) Applicant: Ocean Logic Pty Ltd, Manly NSW (AU)

(72) Inventor: Vincenzo Liguori, Manly NSW (AU)

(73) Assignee: Ocean Logic Pty Ltd, Manly NSW (AU)

(21) Appl. No.: 19/002,539

(22) Filed: Dec. 26, 2024

(30) Foreign Application Priority Data
May 28, 2024 (AU) 2024901588

(51) Int. Cl. G06F 7/523; G06F 7/50

(52) U.S. Cl. CPC G06F 7/523; G06F 7/50

(57) ABSTRACT

Aspects of the invention include a system for accumulating a plurality of input numbers to output a result. The system includes an accumulation subsystem that accepts input numbers that each have a sign bit, an exponent, and a mantissa. The accumulation subsystem includes: a plurality of partial sum registers, each for a particular one of the exponents accumulating a sum of mantissas of numbers having the particular exponent; an adder/subtractor for accumulating the sums; an exponent-indexed decoder to enable a corresponding partial sum register; and an exponent output multiplexor to select the corresponding partial sum register for output. The system further includes a reconstruction subsystem into which are read the partial sums from the partial sum registers, the reconstruction subsystem comprising an adder, a shifter and an output accumulator-register to output said result.

### RELATED APPLICATION

This application claims priority from Australian Provisional Application 2024901588, filed 2024 May 28, said patent application being incorporated herein by reference.

### BACKGROUND

Modern signal processing systems, neural networks, and machine learning systems often require a multiplier accumulators (MACs) with the accumulation being of a large number of numbers, which usually are in floating point format. There thus is a need in the art for methods and systems for efficiently adding a large number of such numbers. Furthermore, there is a need in the art for a MAC that includes adding a large number of floating-point numbers. Furthermore, logarithmic number systems (LNS) are increasingly being used for such applications as neural networks for machine learning, and there thus is a need in the art for an efficient MAC for numbers in an LNS. Furthermore, posit format numbers are known, and there is a need in the art for efficiently adding a large number of posit format numbers.

### SUMMARY

Aspects of the invention include a system for accumulating a plurality of input numbers to output a result. The system includes an accumulation subsystem that accepts input numbers that each have a sign bit, an exponent, and a mantissa. The accumulation subsystem includes: a plurality of partial sum registers, each for a particular one of the exponents accumulating a sum of mantissas of numbers having the particular exponent; an adder/subtractor for accumulating the sums; an exponent-indexed decoder to enable a corresponding partial sum register; and an exponent output multiplexor to select the corresponding partial sum register for output. The system further includes a reconstruction subsystem into which are read the partial sums from the partial sum registers, the reconstruction subsystem comprising an adder, a shifter and an output accumulator-register to output said result.

In some versions, the accumulation subsystem accepts input floating-point numbers one at a time, the an exponent being of ne bits, and the mantissa being of nₘ bits, wherein the adder/subtractor adds or subtracts to or from the mantissa of the input floating-point number, the adding or subtracting depending on the sign bit of the input floating-point number, wherein the decoder that accepts at least some of the bits of the exponent of the input floating-point number to enable the corresponding partial sum register, there being at most Nₑ=2ⁿ^{ₑ} partial sum registers, each having at least nm bits, and being initially set to zero, each partial sum register being to accept the output of said adder/subtractor, wherein the output multiplexor has said at least some of the bits as input to select the corresponding partial sum register for output, wherein said multiplexor output is added or subtracted to said mantissa of the input floating-point number using said adder/subtractor according to said sign bit, wherein the output of said adder/subtractor is stored back into said corresponding partial sum register, and wherein the reconstruction subsystem is clocked, the output of said adder of the reconstruction subsystem is shifted by said shifter, and the accumulator-register accepts the shifter output is fed back to said adder. During each clock cycle, at least one bit of said result is output by shifted starting with the LSB, such that it takes Nₑ cycles for the reconstruction subsystem to complete generating the result, at the end of which the most significant bits of the result are in the accumulator-register.

Aspects of the invention include a system for computing the sum of input numbers. The system including an accumulation subsystem that includes an adder/subtractor that adds or subtracts to or from the mantissa of an input floating-point number, a decoder that accepts at least some of the bits of the exponent of the input floating-point number to enable a corresponding partial sum register of a plurality of partial sum registers, an output multiplexor having the at least some of the bits as input to select the corresponding partial sum register for output, with the multiplexor output added or subtracted to the mantissa of the input floating-point number by the adder/subtractor the output of the adder/subtractor stored back into the corresponding partial sum register. The system includes a reconstruction subsystem into which are read partial sums from the partial sum registers. The reconstruction subsystem includes an adder whose output is shifted by a shifter, and an accumulator-register to accept the shifted quantity and whose output is fed back to the adder.

In some versions, each partial sum register includes additional bits to avoid overflows.

In some versions, the accumulation subsystem keeps track of the minimum value and maximum values of the exponents encountered so that there are fewer partial sum registers.

In some versions, the accumulation subsystem keeps track of the maximum values of the exponents encountered and the results are less than fully accurate by having fewer partial sum registers than for all encountered exponents.

Some versions include a multiplier of two input factors, the system thus forming a multiplier accumulator.

In some versions, the factors of the multiplier system are in a logarithmic number system.

In another aspect, the accumulation subsystem contains fewer partial sum registers, enabled and decoded using at most nₑ−k bits of the nₑ bits of the exponent of the input number, with the remaining k bits used to shift the mantissa of the input floating-point number.

In some versions, the input numbers are in posit format.

### BRIEF DESCRIPTION OF THE DRAWINGS

FIG. 1A shows pseudocode of operation of an accumulator portion of a method of the invention, and FIG. 1B shows pseudocode of operation of a reconstruction portion of a method of the invention.

FIG. 2 shows a simplified schematic of a system implementing the method of FIGS. 1A and 1B.

FIG. 3A shows pseudocode of operation of an accumulator portion of a method of the invention in which fewer partial sums are created, and FIG. 3B shows pseudocode of operation of the reconstruction portion that operates with the method of FIG. 3A.

FIG. 4 shows a simplified schematic of a system implementing the method of FIGS. 3A and 3B.

FIG. 5 shows a simplified schematic of a version of a Kulisch accumulator.

FIG. 6 shows a multiplier accumulator according to an aspect of the present invention.

FIG. 7 shows a picture of the format of a number in a logarithmic number system.

FIG. 8 shows a multiplier accumulator of numbers in a logarithmic number system according to an aspect of the present invention.

### DETAILED DESCRIPTION

### A Method Embodiment

One aspect of the invention is a method of adding a plurality, N, of floating-point numbers, each in the form m2^{e}, where m is the mantissa as a signed integer and e denotes the exponent.

One embodiment of the method comprises creating partial sums, each partial sum being of the mantissas that have the same exponent, then adding the floating numbers formed by the partial sums and their respective exponents.

Let each partial sum Sᵢ for exponent value be

$${S}_{i} = {\sum }_{∀ k : {e}_{k} = i} {m}_{k} . \qquad ( 1 )$$

The sum of the N floating-point numbers {mᵢ2^{e}^{ᵢ}}, i=0, . . . , N−1 is then

$${\sum }_{i = 0}^{N - 1} {m}_{i} {2}^{{e}_{i}} = {\sum }_{i = 0}^{{N}_{e} - 1} {S}_{i} {2}^{i} \qquad ( 2 )$$

where Nₑ=2ⁿ^{ₑ} is the number of partial sums, and nₑ is the number of bits of the exponent. The mantissas mᵢ, i=0, . . . , N−1 are signed integers.

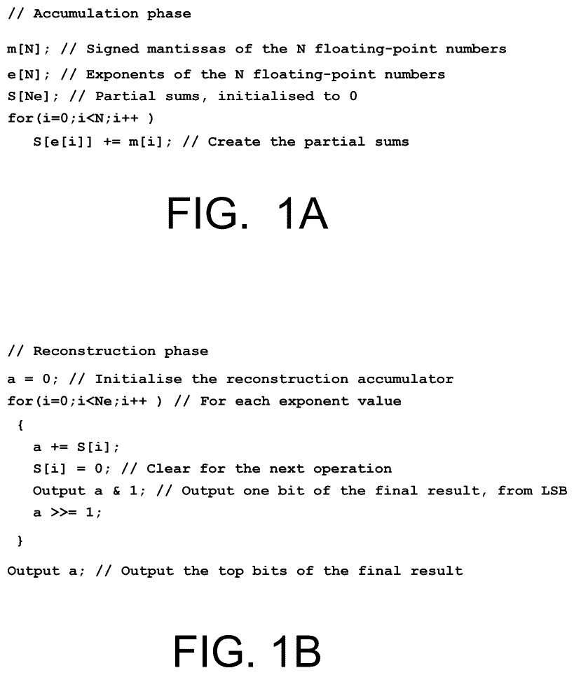

Denote the forming of the partial sums the accumulation phase. This phase can be summarized by the pseudocode shown in FIG. 1A.

Each partial sum is stored in what I call a partial sum register. After the accumulation phase is completed, the reconstruction of the final result can be done by shifting and adding the quantities in the partial sum registers according to Eq. 2. However, using Eq. 2 directly may require dealing with very large numbers. One aspect of the invention is to carry out the reconstruction phase using an accumulator we call the reconstruction accumulator, and shifting out the least significant bit (LSB) of the result one bit at a time as they are calculated, as shown in the pseudo-code of FIG. 1B.

Note that for many cases of interest, N is may be in the order of tens of thousands, such that the time required to carry out the reconstructing phase may be negligible compared to the time for the accumulation phase.

When using a reconstructing accumulator and adder as described in the pseudocode of FIG. 1B, such an accumulator only needs to be one bit larger than the number of bits in the partial sum registers, so that there is no need to deal with large numbers, large additions, or large shifts.

In some cases, there may not be a need for exact precision of the result, and for such cases, in one embodiment, some of the initial least significant bits shifted out are discarded, thus reducing the precision.

One embodiment of the accumulation phase keeps track of the maximum and minimum values of the exponents encountered. Let eₘₐₓ and eₘᵢₙ respectively denote the maximum and minimum values of the exponents encountered. In one embodiment of the reconstruction phase, the extracting of the LSBs of the result loops between eₘᵢₙ and eₘₐₓ instead of between 0 to Nₑ−1. The result, in such a case, will be up to a scaling factor of 2^{e}^{ₘᵢₙ}, and there are only eₘₐₓ−eₘᵢₙ+1 partial sum registers.

Some embodiments provide less than the full accurate results, and this may be sufficient for many applications. In such a case, rather than having the extracting of the result loops be between eₘᵢₙ and eₘₐₓ, the looping is between eₘₐₓ−Δe and eₘₐₓ and there are Δe+1 partial sum registers. The result, in such a case, will be up to a scaling factor of 2^{e}^{ₘₐₓ}^{-Δe}.

### Hardware Implementation

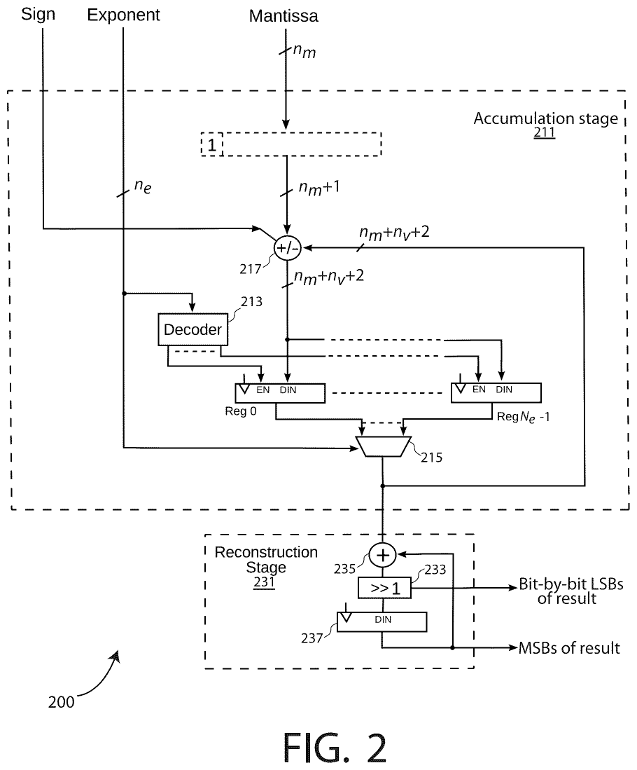

FIG. 2 shows a simplified schematic of a system 200 implementing the method described above. Not shown in the drawing are such aspects as the clock circuitry, the circuitry for setting and resetting registers to zero, and the logic that detects a floating-point value of zero to disables writing back the value.

System 200 includes a clocked accumulation subsystem 211 that accepts one of the N input floating-point numbers to be added, the accepting one at a time. Let ne be the number of bits of the exponents and nₘ be the number of bits of the mantissas of the input floating-point numbers. The accumulation subsystem 211 includes at most Nₑ=2ⁿ^{ₑ} partial sum registers, one for each partial sum, and an adder/subtractor 217 that adds or subtracts a sum of mantissas from one of the partial sum registers to the mantissa input of the input floating-point number (with the hidden mantissa ‘1’ bit), the adding or subtracting depending on the sign bit of the input floating-point number. The partial sum registers of subsystem 211 accept the adder/subtractor output. In order to avoid overflowing, in one embodiment, each partial sum register contains an extra nᵥ bits. In the worst case nᵥ=ceil(log₂ (N)), and this is extremely unlikely to occur in practice as it assumes that all the N numbers being added have the same exponent and the largest possible mantissa. In one embodiment preparing for adding about 10,000 numbers, nᵥ was selected to be 12.

Initially, the system 200 starts with all the partial sum registers set to zero. During accumulation phase, for every floating-point number that is input, the mantissa is reconstructed by including the hidden ‘1’ bit. A decoder 213 accepts the exponent bits and enables the partial sum register corresponding to the exponent. A multiplexor 215 accepts the exponent bits and determines which partial sum register (containing the reconstructed mantissa with the hidden bit included) is read out and added or subtracted using adder/subtractor 217 to the mantissa according to the sign. The result is then stored back into the same partial sum register corresponding to the exponent bits. This happens in the same clock cycle.

The system 200 includes a clocked reconstruction subsystem 231 that is used for the reconstruction phase. The partial sums are read sequentially from the partial sum registers (for example, using multiplexor 215 by providing sequential addresses through the exponent input) and the final result is reconstructed with an accumulator-register 237, a shifter 233, and an adder 235 as described in the pseudo-code of FIG. 1B. The output of the adder is input to the shifter and the shifted quantity is input back to the accumulator-register 237. During each cycle of the reconstruction phase, a result bit is output by shifter 233 starting with the LSB of the result. It takes at most Nₑ cycles for the complete reconstruction phase, at the end of which the most significant bits of the result are in accumulator-register.

For clarity, not shown in the drawing is the clocking circuitry, and a circuit that initially sets to zero the partial sum registers, including at the end as they are read out. Note that the partial sum registers do not need to be cleared if more numbers are to be added.

One embodiment of the accumulation phase circuit 211 keeps track of the maximum and minimum values of the exponents encountered. Let eₘₐₓ and eₘᵢₙ respectively denote the maximum and minimum values of the exponents encountered. In one embodiment of the reconstruction phase, the extracting of the LSBs of the result need only loop between eₘᵢₙ and eₘₐₓ instead of between 0 to Nₑ−1. The result, in such a case, will be up to a scaling factor of 2^{e}^{ₘᵢₙ}, and there are only eₘₐₓ−eₘᵢₙ+1 partial sum registers in the accumulation subsystem 211. Rather than the register indexing stating with Reg 0 as shown in the drawing, the indexing of the registers starts with Reg(eₘᵢₙ) and ends with Reg(eₘₐₓ). Thus, if during partial sum storage the circuit 211 keeps track of minimum and maximum exponent values, only eₘₐₓ−eₘᵢₙ+1 cycles will be required.

Some embodiments provide less than the full accurate results, and this may be sufficient for many applications. In such a case, rather than having the extracting of the result loops be between eₘᵢₙ and eₘₐₓ, the looping is between eₘₐₓ−Δe and eₘₐₓ and there are Δe+1 partial sum registers. The result, in such a case, will be up to a scaling factor of 2^{e}^{ₘₐₓ}^{Δe}.

During the reconstruction, one bit of the final result will be output for each clock cycle, from LSB onwards. At the end, the accumulator-register 237 will contain the MSBs of the final result.

Note that this design can be easily pipelined. Also note that, for clarity and simplicity, the reconstruction stage is shown in FIG. 2 as distinct from the accumulation stage. In reality, since the two adders shown are not used at the same time, there are quite a few ways to share a single adder between the two phases. A similar observation can be made for the accumulator-register 237 that can also be shared with the partial sum registers.

### Reducing the Number of Partial Sums Registers

The above-described method and block diagram includes a partial-sum register for each exponent, which may lead to a large number of partial-sum registers. In another aspect of the invention, sets of a pre-selected number of exponents are assigned to the same respective register. Let k be a parameter k that can have a value of 0 to nₑ. In such a case, only 2ⁿ^{ₑ}^{-k} registers are needed, and each of these accumulates mantissas that have exponents that part of a set of 2^{k} values.

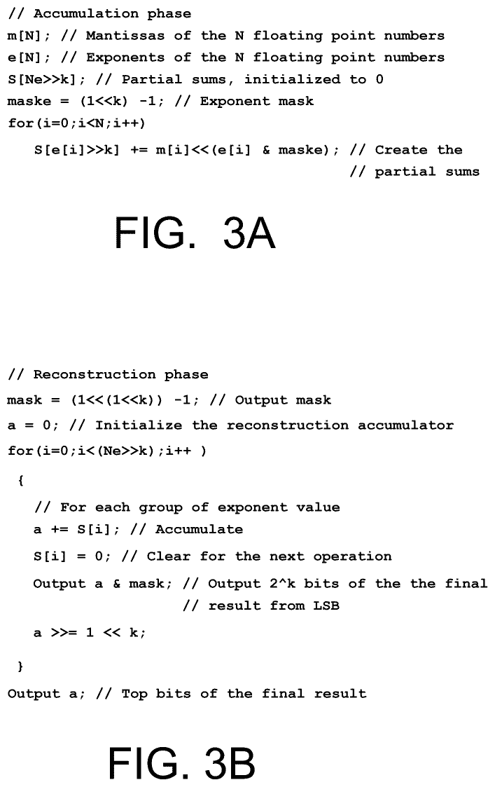

Each mantissa within such group needs to be shifted left by an amount that varies from 0 to 2^{k}−1before being added to a partial sum register. FIG. 3A shows pseudocode of one embodiment of an accumulation in which each partial-sum register groups 2^{k} values. There are now have 2ⁿ^{ₑ}^{-k} registers, one for each group of exponents. There is a need for a [0 . . . 2^{k}−1] bit shifter and the partial sums require an additional 2^{k} bits. As shown, the partial sums are of the mantissas whose index is shifted by “e[i]” masked by mask “maske.” Essentially, k least significant bits from the exponent are used to left shift the incoming mantissa while the remaining nₑ−k bits are used to select a partial sum register.

FIG. 3B shows the one embodiment of the reconstruction phase for the grouping of 2^{k} value. During the reconstruction phase 2^{k} bits of the result are shifted out every clock cycle, starting from the LSB. At the end of the reconstruction phase the reconstruction accumulator contains the MSBs of the result.

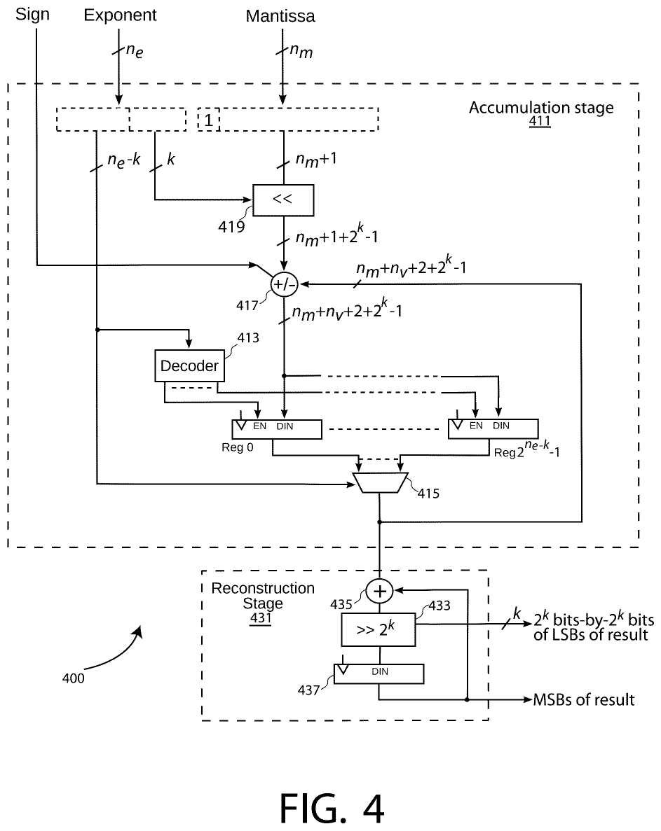

FIG. 4 shows a schematic of one hardware system 400 implementing the flowcharts of FIGS. 3A and 3B. Again, not shown in the drawing are such aspects as the clock circuitry, the circuitry for setting and resetting registers to zero, and the logic that detects a floating-point value of zero to disables writing back the value.

An accumulation subsystem 411 comprises 2ⁿ^{ₑ}^{-k} partial sum registers, and uses nₑ−k most significant bits of the exponent for enabling and selecting particular one of these partial sum registers. A k-bit shifter 419 uses the k LSBs of the exponent to shift left the mantissa (reconstructed with the hidden ‘1’ bit) of the input floating-point number. The subsystem 411 includes an adder/subtractor 417 that adds or subtracts the mantissas to the selected partial sum register. The 2ⁿ^{ₑ}^{-k} partial sum registers of subsystem 411 accept the adder/subtractor output. As before, each partial sum register contains an extra nᵥ bits to avoid overflows. As before, the system 400 starts with all the partial sum registers set to zero. During accumulation phase, for every floating-point number that is input, a decoder 413 accepting nₑ−k bits of the exponent to enable the corresponding partial sum register. A multiplexor 415 determines which the partial sum (the reconstructed mantissa with the hidden bit included) to be read out and added or subtracted using adder/subtractor 417 to according to the sign. The result is then stored back into the same partial sum register. This happens in the same clock cycle.

A reconstruction stage 431 is used for the reconstruction phase. The partial sums are read sequentially from the partial sum registers. The final result is reconstructed with an accumulator-register 437, a 2^{k}-bit shifter 433, and an adder 435 as described in the pseudo-code of FIG. 3B.

During each cycle of the reconstruction phase, a result bit is output by shifter 433 starting with the 2^{k} LSBs of the result. It takes at most 2ⁿ^{ₑ}^{-k} cycles to complete the reconstruction phase, at the end of which the most significant bits of the result are in accumulator-register 437.

In one embodiment preparing for the. addition of about 10,000 numbers with nᵥ selected to be 12, k was selected to be 3.

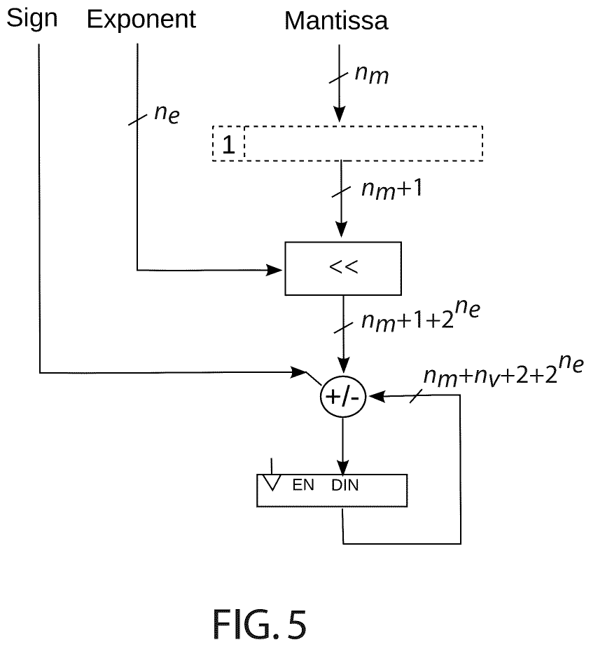

Note that, for k=0, we have the architecture described in FIG. 2, while, for k=nₑ, the architecture shown in FIG. 5 results, and this may be recognized as a version of a Kulisch accumulator.

For an exact result during the reconstruction phase, the methods and systems described above operate for all the 2ⁿ^{ₑ}^{-k} groups of exponents. Define the minimum group of exponents, denoted geₘᵢₙ to be the group to which the minimum encountered exponent belongs, and define the maximum group of exponents, denoted geₘₐₓ, to be the group to which the maximum encountered exponent belongs. In an improved embodiment, the reconstruction phase operates on the partial sums registers indexed from geₘᵢₙ to geₘₐₓ. In many cases an approximate rather than the exact result is sufficient, and the reconstruction may be carried out using fewer partial sum registers starting from a few below geₘₐₓ up to geₘₐₓ. This provides a faster, albeit less accurate result. In both cases, the result will be up to a scaling factor of 2 to the power of the smallest exponent belonging to the geₘᵢₙ group.

### A System for Multiply/Accumulate Operations

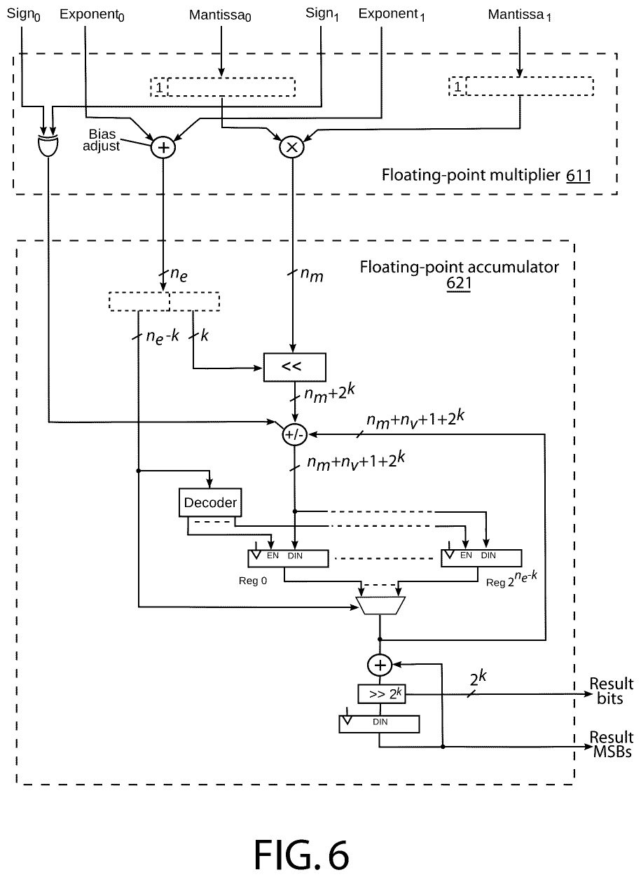

One aspect of the invention is using any of the above-described systems to combine with a floating-point multiplier of two input floating-point factors to carry out multiply/accumulate (MAC) operations. A schematic of one such system 600 is shown in FIG. 6.

As shown, in floating-point multiplier element 611, two input factors' mantissas are reconstructed and multiplied together, while the factors' exponents are added and the sign of the result is determined by an XOR of the sign bits. The resulting sign, exponent and mantissa are accumulated in a floating-point accumulator, in this case, element 621 that is essentially as previously described in FIG. 4, although other embodiments of a floating-point accumulator, e.g., that shown in FIG. 2 may be used. Note that there is no need to normalize the result of the multiplication and nₘ indicates here the number of bits resulting from said multiplication. Also note that, in some floating-point representations, the exponents are biased and, in this case, their sum needs to be adjusted.

### An Posit Accumulator and a MAC for Posits

The posit format for numbers is one that includes an additional field that defines the number of bits in the exponent, such that posits may be considered as being floating-point numbers with a variable size mantissa whose size depends on the value of the exponent and the number of bits therein. Therefore, each posit format number can for converted to and from a floating-point format m2^{e}, it's just that the number of bits nₘ for the mantissa m is variable.

A floating-point accumulator architecture such as that shown in FIG. 2 or FIG. 4 may be used, except that the partial sum registers will have a variable number of bits. During the reconstruction phase, the partial sum registers need to be padded with zeros so that they each have the same number of bits, so that they can be added together.

For a MAC for posits, the architecture of FIG. 6 may be used.

### Logarithmic MACs

A logarithmic number system (LNS) has recently emerged as an alternative to floating-point systems (FPS) in applications where low number of bits are possible such as neural networks. Given the same number bits, an LNS has a lower quantization error than an FPS. An LNS number V with sign bit s may be represented as a floating point number:

$$V = {( - 1 )}^{s} {2}^{ei . ef} = {( - 1 )}^{s} {2}^{ei + 0. ef} = {( - 1 )}^{s} {2}^{ei} {2}^{0. ef} = {( - 1 )}^{s} m {2}^{ei} , \qquad ( 3 )$$

where ei and ef are, respectively, the integer and fractional parts of the exponent, and m=2^{0.ef}.

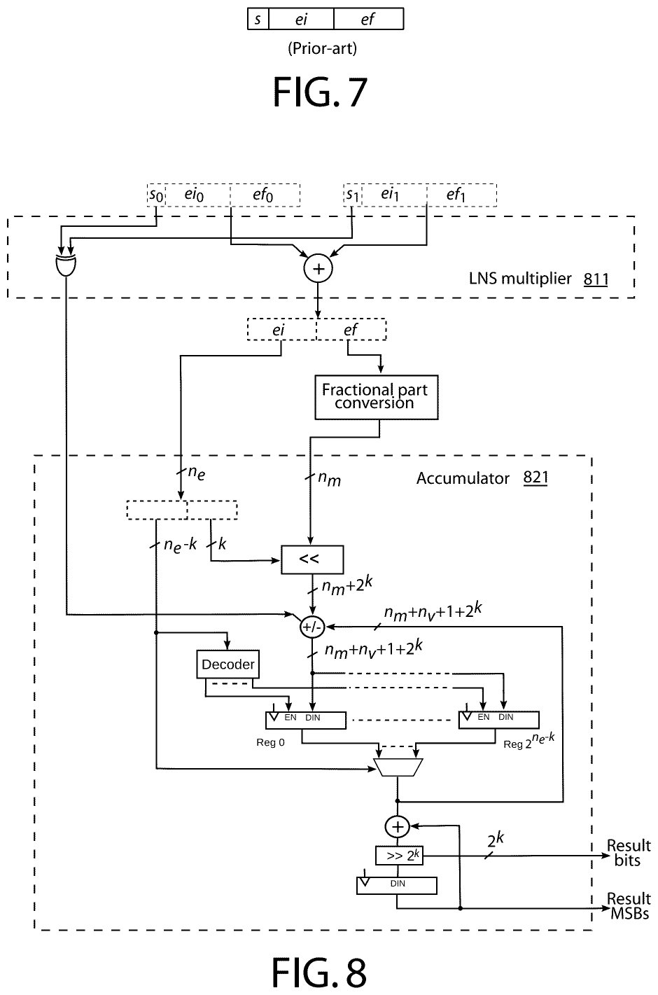

FIG. 7 shows a picture of the format of a number in a LNS, with s=1 as usual indicating a negative number. In addition to the lower quantization error compared to an FPS representation, an advantage of an LNS is that multiplication is carried out with addition. The concatenation of ei and ef can be considered an unsigned fixed-point number, and multiplication is straightforward addition, with the sign bits of the multiplicands excusive ORed for the result sign bit.

Note that as is known, in an LNS, zero cannot be represented directly. One either uses the smallest number that can be represented, or instead assigns a special code to it.

LNS addition on the other hand is more complicated. Numbers in an LNS need be converted to ordinary numbers before actually being added. This, in turn, can result in loss of precision for example over a large number of additions.

For addition, in one embodiment, the fractional part of the logarithmic representation is converted to a finite number of digits. In one version, this is done using a look up table. After that, there's no further loss of accuracy, subject to the chosen reconstruction strategy.

FIG. 8 shows a schematic of one embodiment of a MAC of numbers in an LNS. The multiplication subsystem 811 includes an exclusive OR for the signs of the two LNS factors while the result itself is obtained by adding the two fixed point numbers from the concatenations of the integer and fractional parts of the factors. The result will also have an integer and fractional part. As the resulting fractional part is generally only a few bits, it can be converted to the form 2^{0.ef} with a simple lookup table.

After the multiplication and conversion of the fractional part to a mantissa form, the resulting sign, the integer part of the multiplication as an exponent, and the mantissa form are be then accumulated. In the version illustrated in FIG. 8, this is carried out by an accumulator subsystem 821 that is essentially that of FIG. 4. The architecture of FIG. 2 may be used in an alternate embodiment.

In the above-described embodiments, the mantissa may be a signed two's complement number.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

1. A system for accumulating a plurality of input numbers to output a result, the system comprising:
an accumulation subsystem that accepts input numbers that each have a sign bit, an exponent, and a mantissa, the accumulation subsystem comprising:
a plurality of partial sum registers, each for at least part of a particular one of the exponents, each partial sum register accumulating a sum of mantissas of numbers having the particular exponent;
an adder/subtractor for accumulating the sums;
an exponent-indexed decoder to enable a corresponding partial sum register and an exponent output multiplexor to select the corresponding partial sum register for output; and
a reconstruction subsystem into which are read the partial sums from the partial sum registers, the reconstruction subsystem comprising an adder, a shifter and an output accumulator-register to output said result.

2. The system of claim 1,
wherein the accumulation subsystem accepts input floating-point numbers one at a time, said exponent being of nₑ bits, and said mantissa being of nₘ bits,
wherein the adder/subtractor adds or subtracts to or from the mantissa of the input floating-point number, the adding or subtracting depending on the sign bit of the input floating-point number, wherein the decoder that accepts at least some of the bits of the exponent of the input floating-point number to enable the corresponding partial sum register, there being at most Nₑ=2ⁿ^{ₑ} partial sum registers, each having at least nₘ bits, and being initially set to zero, each partial sum register being to accept the output of said adder/subtractor,
wherein the output multiplexor has said at least some of the bits as input to select the corresponding partial sum register for output,
wherein said multiplexor output is added or subtracted to said mantissa of the input floating-point number using said adder/subtractor according to said sign bit,
wherein the output of said adder/subtractor is stored back into said corresponding partial sum register,
wherein the reconstruction subsystem is clocked, the output of said adder is shifted by said shifter, and the accumulator-register accepts the shifter output is fed back to said adder, and
wherein during each clock cycle, at least one bit of said result is output by shifted starting with the LSB, such that it takes Nₑ cycles for the reconstruction subsystem to complete generating the result, at the end of which the most significant bits of the result are in the accumulator-register.

3. The system of claim 2 wherein each partial sum register includes an additional nᵥ bits to avoid overflows.

4. The system of claim 3, wherein the accumulation subsystem keeps track of the minimum value eₘᵢₙ and maximum value eₘₐₓ of the exponents encountered, wherein there are at most eₘₐₓ−eₘᵢₙ+1 partial sum registers, and wherein extracting of the LSBs of the result need only loop between eₘᵢₙ and eₘₐₓ.

5. The system of claim 3, wherein the accumulation subsystem keeps track of the maximum value eₘₐₓ of the exponents encountered during accumulation by the accumulation subsystem, wherein there are Δe+1 partial sum registers, eₘₐₓ−Δe being larger than (or equal to) the minimum exponent encountered during the accumulation, and wherein extracting of the LSBs of the result need only loop between eₘₐₓ−Δe and eₘₐₓ such that the result is less than fully accurate.

6. The system of claim 3, wherein the input numbers are in posit format and converted to floating-point numbers with the number of bits nₘ for the mantissas being variable, such that the partial sum registers have a variable number of bits that need to be padded to have the same number of bits to be added together.

7. The system of claim 3, further comprising a multiplier of two input floating-point factors, such that the input floating-point numbers are the outputs of said multiplier, the system thus forming a multiplier accumulator.

8. The system of claim 3 wherein the mantissa is a signed two's complement number.

9. The system of claim 3, further comprising:
a multiplier of two input factors each in a logarithmic number system having a first and a second input signs, a first input integer part. and a second input integer part, and a first and a second input fractional part, the multiplier comprising an exclusive or gate to exclusive OR the first and second input signs to produce the sign bit of the input floating-point number of the accumulation subsystem, and an adder that adds together the concatenations of the first integer with the first fractional part and of the second integer with the second fractional part, the result of the summing having a multiplied integer part and a multiplied fractional part; and
a convertor to convert the multiplied fractional part to a mantissa form for the accumulation subsystem,
wherein the multiplied integer part forms the exponent of the accumulation subsystem.

10. The system of claim 3, wherein the accumulation subsystem contains at most 2ⁿ^{ₑ}^{-k} partial sum registers, enabled and decoded using at most nₑ−k bits of the exponent of the input floating-point number, the remaining k bits used to shift the mantissa of the input floating-point number so that the adder/subtractor accepts nₘ−k bits, and wherein the shifter of the reconstruction subsystem is by 2^{k} bits outputting 2^{k} bits of the output at a time.

11. The system of claim 10,
wherein the accumulation subsystem keeps track of the group geₘᵢₙ of exponents in which the minimum encountered exponent value occurs and the group geₘₐₓ of exponents in which the maximum encountered exponent value occurs,
wherein there are at most geₘₐₓ−geₘᵢₙ+1 partial sum registers, and
wherein extracting of the LSBs of the result need only loop between geₘᵢₙ and geₘₐₓ.

12. The system of claim 10,
wherein the accumulation subsystem keeps track of the group geₘₐₓ of exponents in which the maximum encountered exponent value occurs,
wherein there are Δe+1 partial sum registers, geₘₐₓ−Δe being larger than (or equal to) the minimum group of exponents encountered during the accumulation, and
wherein extracting of the LSBs of the result need only loop between geₘₐₓ−Δe and geₘₐₓ such that the result is less than fully accurate.

13. The system of claim 10, further comprising a multiplier of two input floating-point factors, such that the input floating-point numbers are the outputs of said multiplier, the system thus forming a multiplier accumulator.

14. The system of claim 10 wherein the mantissa is a signed two's complement number.

15. The system of claim 10, wherein the input numbers are in posit format and converted to floating-point numbers with the number of bits nₘ for the mantissas being variable, such that the partial sum registers have a variable number of bits that need to be padded to have the same number of bits to be added together.

16. The system of claim 10, further comprising:
a multiplier of two input factors each in a logarithmic number system having a first and a second input signs, a first and a second input integer part, and a first and a second input fractional part, the multiplier comprising an exclusive or gate to exclusive OR the first and second input signs to produce the sign bit of the input floating-point number of the accumulation subsystem, and a multiplication adder that adds together the concatenations of the first integer with the first fractional part and of the second integer with the second fractional part, the result of the summing having a multiplied integer part and a multiplied fractional part; and
a convertor to convert the multiplied fractional part to a mantissa form for the accumulation subsystem,
wherein the multiplied integer part forms the exponent of the accumulation subsystem.
